(19) United States
(12) Patent Application Publication
(10) Pub. No.: US 2023/0354992 A1
(43) Pub. Date: Nov. 9, 2023

(54) COMPACT TOOTHBRUSH WITH GIMBLE-MOUNTED VIBRATION MOTOR

(71) Applicant: BURST.USA Inc., Walnut, CA (US)

(72) Inventors: Hamish KHAYAT, Austin, TX (US); Keith ALSBERG, Chicago, IL (US)

(21) Appl. No.: 17/736,705

(22) Filed: May 4, 2022

(51) Int. Cl. A46B 13/02; H01M 50/247; A61C 17/22

(52) U.S. Cl. CPC A46B 13/023; H01M 50/247; A61C 17/225; A61C 17/221; H01M 2220/30

(57) ABSTRACT

An electronic toothbrush including a toothbrush head assembly extending in an axial direction. The toothbrush head assembly has a toothbrush head supporting a plurality of bristles oriented in a direction transverse to the axial direction. A motor cup assembly includes a motor cup and a shaft member extending into a neck portion of the toothbrush head assembly. An electric vibration motor is secured by the motor cup. A handle housing circumscribes the motor cup, a chassis structure and control electronics. A gimbal arrangement includes a gimbal pin oriented substantially perpendicular to the axial direction and received by the chassis structure. The gimbal arrangement constrains vibrational displacement of the shaft member arising from vibrational energy produced by the electric vibration motor to within a plane substantially normal to a longitudinal axis of the gimbal pin. The shaft member causes the toothbrush head assembly to be displaced within the plane.

### FIELD

The present disclosure relates generally to toothbrushes and, more particularly, to toothbrushes driven by electronic motors.

### BACKGROUND

Existing electronically-driven toothbrushes generally include a brush head detachable from a handle or body portion. The brush head typically has a set of bristles which are vibrated or rotated when the brush head is vibrated or rotated by a motor disposed within the handle portion. Such movement of the bristles facilitates cleaning of a user's teeth and/or gums during operation of the toothbrush. However, vibration of the motor during operation of the toothbrush may also induce a vibration in the handle. This vibration, which may be substantial when inexpensive, lower-end vibration motors are utilized, may degrade the experience of the user. Vibration within the handle is also inefficient since it consumes vibrational energy produced by the motor which could otherwise be directed to the brush head. In addition, the use of such lower-end vibration motors often results in a largely random motion of the brush head rather than the side-to-side motion generally recommended. Although motors designed to facilitate the preferred side-to-side brushing pattern are available, such motors tend to be relatively costly.

### SUMMARY

Disclosed herein is an electronic toothbrush including a toothbrush head assembly extending in an axial direction. The toothbrush head assembly has a neck portion and a toothbrush head supporting a plurality of bristles oriented in a direction transverse to the axial direction. A motor cup assembly includes a motor cup and a shaft member extending into the neck portion of the toothbrush head assembly. An electric vibration motor is secured by the motor cup. A chassis structure has a longitudinal axis oriented in the axial direction. Control electronics are electronically connected to the electric vibration motor. A handle housing circumscribes the motor cup, the chassis structure and the control electronics. A gimbal arrangement includes a gimbal pin oriented substantially perpendicular to the axial direction and received by the chassis structure. The gimbal arrangement is configured to constrain vibrational displacement of the shaft member arising from vibrational energy produced by the electric vibration motor to within a plane substantially normal to a longitudinal axis of the gimbal pin. The shaft member causes the toothbrush head assembly to be displaced within the plane.

The electric vibration motor may be an eccentric rotating mass (ERM) vibration motor including a motor housing and having a non-symmetric weight attached to a motor shaft extending from a first end of the motor housing. The ERM vibration motor may be oriented in an inverted configuration in which the first end of the motor housing is displaced farther from the toothbrush head than a second end of the motor housing opposite to the first end of the motor housing. Alternatively, the ERM vibration motor is oriented so that the first end of the motor housing is closer to the toothbrush head than is a second end of the motor housing opposite to the first end of the motor housing.

The gimbal pin may be rotatably disposed within the first and second apertures such that the motor cup is configured to rotate relative to the gimbal pin. Alternatively, the gimbal pin is secured to the motor cup and extends into receiving portions defined by the chassis such that the gimbal pin is configured to rotate within the receiving portions. The motor cup includes a first end secured to the shaft member and a second end through which extends a housing of the electric vibration motor. The electronic toothbrush may further include a boot member attached to the chassis and forming a seal against an external surface of the shaft member proximate the first end of the motor cup.

The electronic toothbrush may further include a battery secured by the chassis structure.

### BRIEF DESCRIPTION OF THE DRAWINGS

FIG. 1 is a perspective view of an electronic toothbrush having a gimbaled electric vibration motor in accordance with an embodiment.

FIGS. 2A and 2B are side and front views, respectively, of the electronic toothbrush in accordance with an embodiment.

FIG. 3 is an exploded view of the electronic toothbrush in accordance with an embodiment.

FIGS. 4A and 4B are side and rear sectional views, respectively, of the electronic toothbrush in accordance with an embodiment.

FIG. 5 is a front sectional view of the electronic toothbrush in accordance with an embodiment.

FIG. 6A is a front perspective view of a body section of the electronic toothbrush in accordance with an embodiment.

FIG. 6B is a front perspective view of internal components of a body section of the electronic toothbrush in accordance with an embodiment.

FIG. 7A is a partially disassembled perspective view of a chassis included within the body section of the electronic toothbrush in accordance with an embodiment.

FIG. 7B is a partially disassembled front view of a chassis structure included within the body section of the electronic toothbrush in accordance with an embodiment.

FIGS. 8A-8C provide bottom perspective views of a bottom seal unit, chassis structure, and handle housing, respectively.

FIGS. 9A-9B provide front perspective and rear views, respectively, of a gimbaled electric vibration motor arrangement in accordance with the disclosure.

FIG. 10 is a quarter sectional view of a portion of the electric toothbrush containing the gimbaled electric vibration motor arrangement in accordance with the disclosure.

FIG. 11 is a side sectional view of a portion of the electric toothbrush containing the gimbaled electric vibration motor arrangement in accordance with the disclosure.

FIG. 12 is a front sectional view of a portion of the electric toothbrush containing the gimbaled electric vibration motor arrangement in accordance with the disclosure.

FIG. 13 is a quarter sectional view of an electric toothbrush containing an alternate orientation of a gimbaled electric vibration motor arrangement in accordance with the disclosure.

FIGS. 14A and 14B are front and side sectional views, respectively, of the electronic toothbrush of FIG. 13.

FIG. 15 is a quarter sectional view of a portion of the electric toothbrush containing the gimbaled electric vibration motor arrangement in the alternate orientation of FIG. 13.

FIG. 16 is a sectional view of a portion of the electric toothbrush containing the gimbaled electric vibration motor arrangement in the alternate orientation of FIG. 13.

### DETAILED DESCRIPTION

Disclosed herein are exemplary embodiments of a compact electric powered toothbrush suitable for use as, for example, portable travel electric powered toothbrushes. As one example, an electric toothbrush includes a toothbrush head assembly extending in an axial direction. The toothbrush head assembly includes a neck portion and a toothbrush head supporting a plurality of bristles oriented in a direction transverse to the axial direction. A motor cup assembly includes a motor cup and a shaft member extending into the neck portion of the toothbrush head assembly. An electric vibration motor disposed within the motor cup produces vibrational energy. A chassis structure has a longitudinal axis oriented in the axial direction. Control electronics are electronically connected to the electric vibration motor. A handle housing circumscribes the motor cup, the chassis structure and the control electronics. A gimbal arrangement is supported by the chassis structure and includes a gimbal pin oriented substantially perpendicular to the axial direction and received by the chassis structure. The gimbal arrangement is configured to constrain vibrational displacement of the shaft member arising from the vibrational energy produced by the electric vibration motor to be within a plane substantially normal to a longitudinal axis of the gimbal pin. This configuration results in the shaft member causing the toothbrush head to be displaced within the plane while inhibiting displacement of the toothbrush head out of the plane.

The motor cup defines first and second apertures through which extends the gimbal pin of the gimbal arrangement. The gimbal pin may be rotatably disposed within the first and second apertures such that the motor cup is configured to rotate relative to the gimbal pin, which may be secured by receiving portions of the chassis structure. Alternatively, the gimbal pin may be secured to, or integrated with, the motor cup such that the motor cup does not rotate relative to the gimbal pin. In this case the gimbal pin extends into, and rotates within, the receiving portions defined by the chassis. The shaft member may define a third aperture through which the gimbal pin also extends. The motor cup includes a first end secured to the shaft member and a second end through which extends a housing of the electric vibration motor. The electronic toothbrush may further include a boot member attached to the chassis. The boot member forms a seal against an external surface of the shaft member proximate the first end of the motor cup.

One implementation of the toothbrush particularly suitable for travel applications includes a battery secured by the chassis structure. The electric vibration motor may be an eccentric rotating mass (ERM) vibration motor and may include a motor housing having a first end and a second end. The ERM vibration motor may be configured so that a first end of the motor housing is proximate a shaft member secured by the motor cup. A motor shaft extends from the second end of the motor housing, and a non-symmetric weight is attached to the motor shaft. The ERM vibration motor may be arranged in a first orientation such that the second end of the motor housing and the non-symmetric weight are displaced farther from the gimbal pin than the first end of the motor housing; that is, the motor shaft to which the non-symmetric weight is attached extends from the motor housing in a downward direction away from the gimbal pin. As is discussed below, this configuration effectively increases the length of a lever arm associated with the shaft member and thereby allows for greater displacement of the toothbrush head. Alternatively, the ERM vibration motor may be configured and arranged in a second orientation such that the motor shaft extends in a direction opposite to the downward direction. In this second orientation the non-symmetric weight is closer to the gimbal pin than is the motor housing.

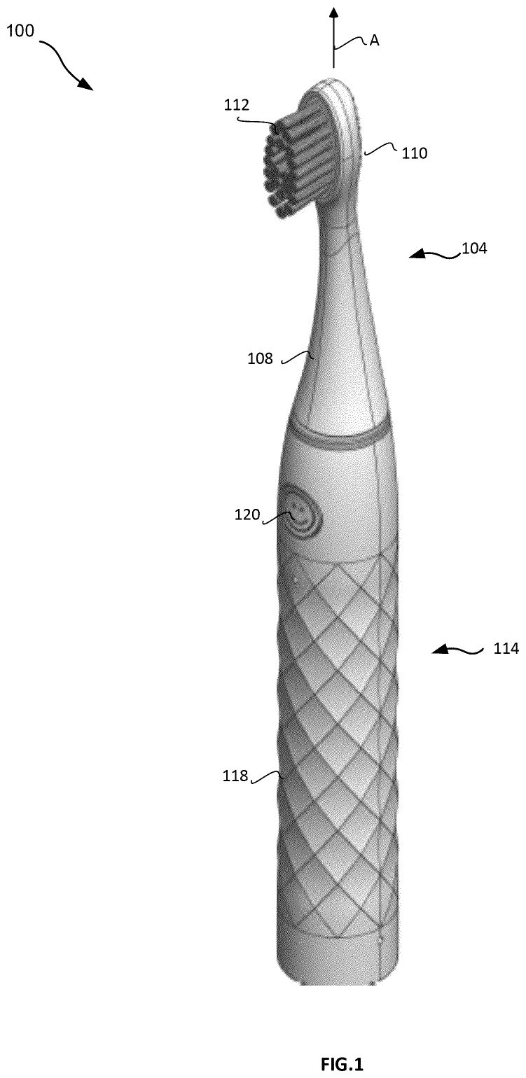

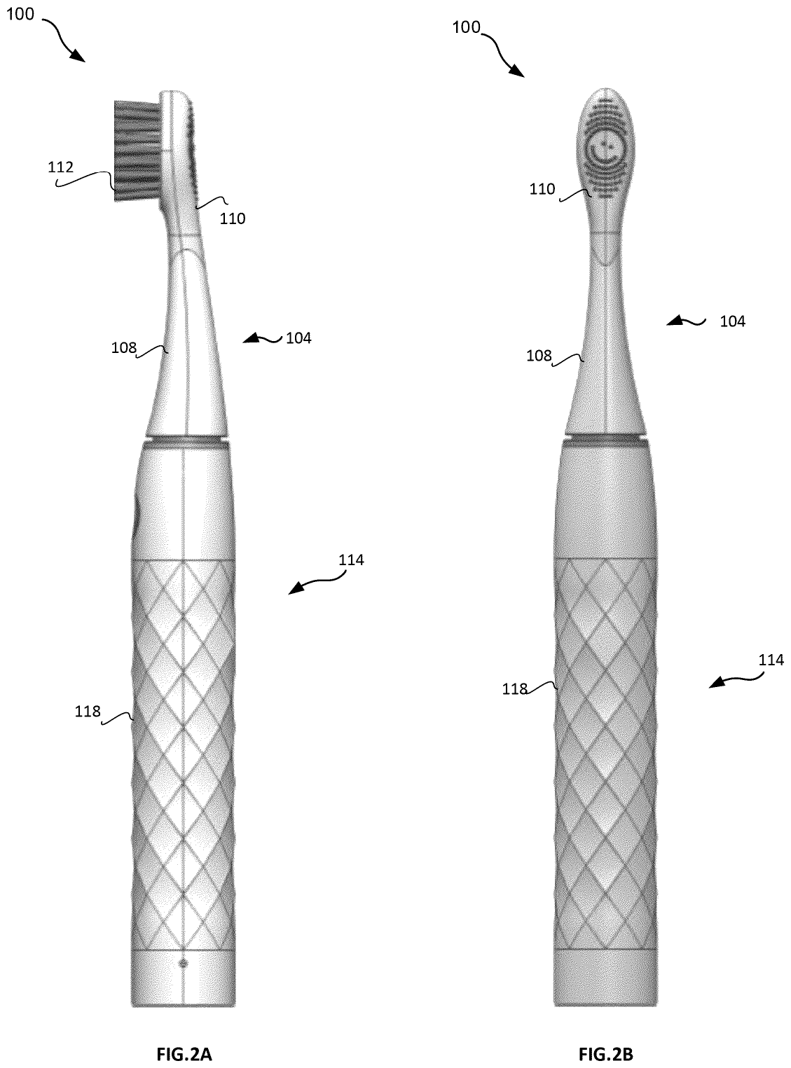

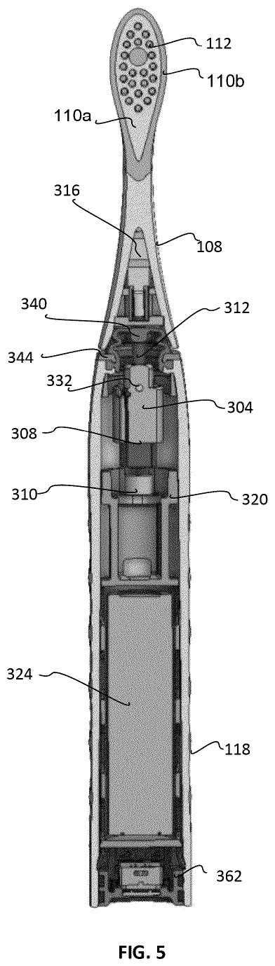

Turning now to the various views of the electronic toothbrush provided by FIGS. 1-8, the electronic toothbrush will now be described in further detail. The toothbrush 100 may include a replaceable toothbrush head assembly 104 extending in an axial direction A. The replaceable toothbrush head assembly 104 includes a neck portion 108 and a toothbrush head 110 supporting a plurality of bristles 112 oriented in a direction transverse to the axial direction. The neck portion 108 may be made of plastic or other materials, and may form a rigid or semi-flexible support for the head 110. A body section 114 is of generally cylindrical shape and tapers down in circumference proximate the bottom of the toothbrush head assembly 104, which may be detached from the body section 114 to facilitate replacement. A handle housing 118 of the body section 114 provides a surface which is gripped by a user's hand during operation of the toothbrush 100. A control button 120 may be defined within an upper portion of the body section 114 in order to enable a user to turn the toothbrush 100 on or off, select different modes of operation, or adjust speeds or settings associated with a selected operational mode.

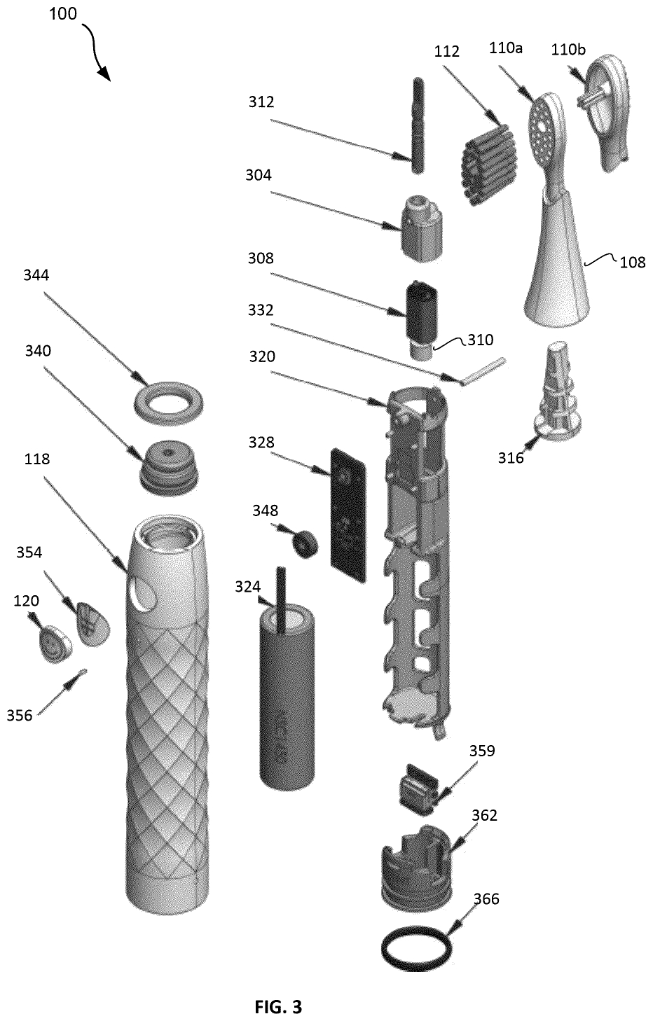

FIG. 3 is an exploded view of an embodiment of the electric toothbrush 100. As shown, a motor cup assembly includes a motor cup 304 and an electric vibration motor 308. The motor 308, which is secured by the motor cup 304, has a shaft to which is attached an eccentric weight 310. A shaft member 312 is secured within an aperture defined by an upper end of the motor cup 304. When the toothbrush 100 is an assembled state, the shaft member 312 is surrounded by a brush head insert 316, which fits within the neck portion 108 of the toothbrush head assembly 104.

The vibration motor 308 may be implemented using commercially available vibration motors such as, for example, vibration motors capable of operating at a speed of 17800 rpm or greater (unloaded), a torque of 2.0 g-cm (at max efficiency), and an output of 0.28 W (at max efficiency). Vibration motors having substantially different operational parameters may be suitable for use in other implementations of the toothbrush 100.

A chassis structure 320 is axially aligned with the motor cup 304, motor 308 and shaft member 312. The chassis structure 320 may support and secure a battery 324 as well as a printed circuit board 328 implementing control electronics. The handle housing 118 circumscribes the motor cup 304, the motor 308, the chassis structure 320 and the printed circuit board 328.

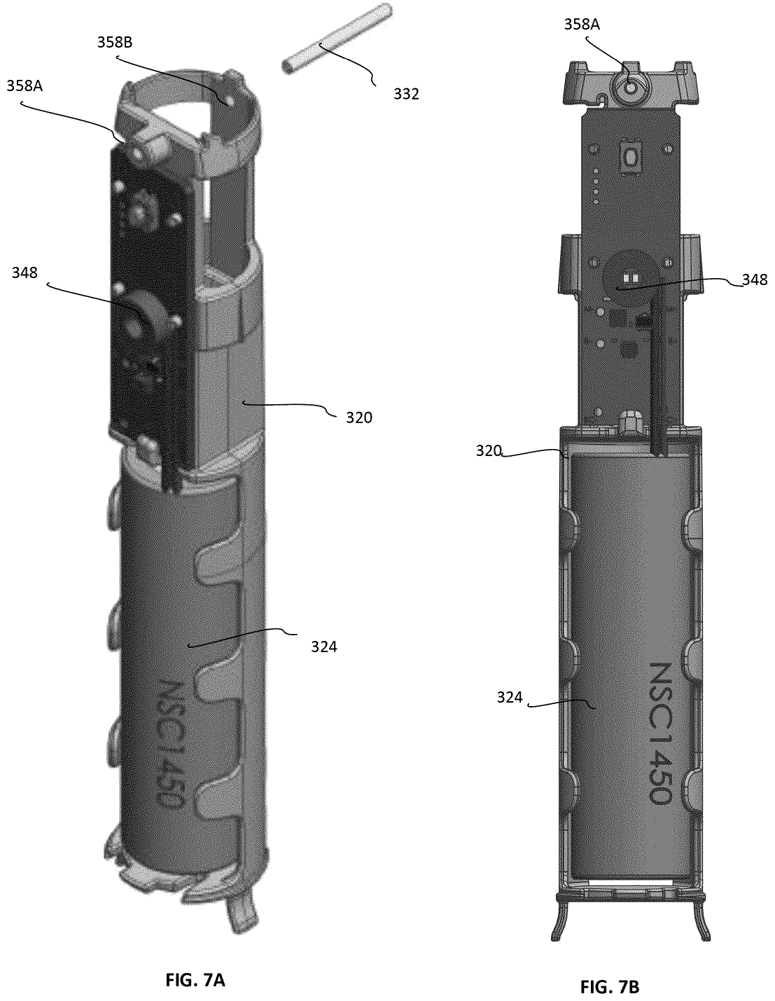

A gimbal arrangement includes (i) a gimbal pin 332 oriented substantially perpendicular to the axial direction, (ii) receiving portions 358 (FIG. 7) defined by the chassis structure 320 and configured to receive the gimbal pin 332, and (iii) apertures defined by the motor cup 304 through which the gimbal pin 332 extends. The gimbal arrangement is designed to constrain vibrational displacement of the shaft member 312 arising from vibrational energy produced by the electric vibration motor 308 to be within a plane substantially normal to a longitudinal axis of the gimbal pin 312. This results in the toothbrush head assembly 104 being displaced within this plane during operation of the toothbrush 100 while isolating such vibrational energy from the handle housing. A boot member 340 attaches to the chassis 320 and forms a seal against an external surface of the shaft member 312 so as to prevent moisture or other contaminants from entering the interior portion of the body section 114. A retaining ring 344 is sandwiched between an upper rim of the body section 114 and a lower rim of the neck portion 108 of the toothbrush head assembly 104.

The electronic toothbrush further includes a foam gasket 348, a button membrane 354, an LED aperture plug 356, a printed circuit board and USB connector module 359, a bottom seal unit 362 within which the module 358 is secured, and an O-ring 366 to facilitate sealing of the interior space defined by the body section 114.

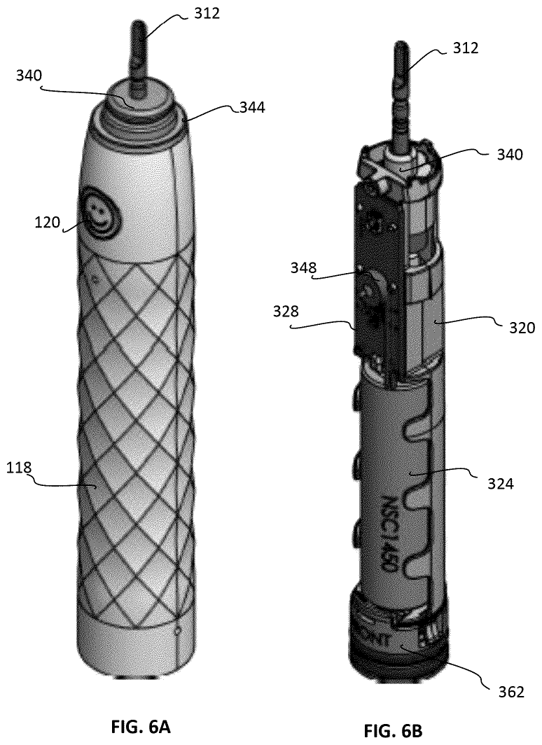

As shown in FIG. 6, the bottom seal unit 362 preferably snap locks to the chassis 320, which is dimensioned as to be capable of insertion within the housing 118.

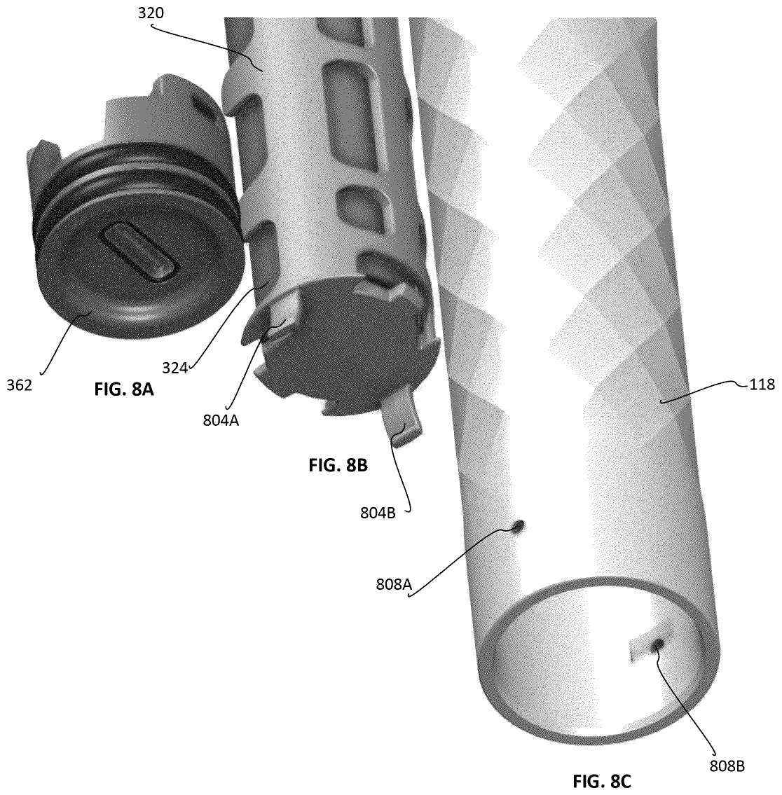

As is indicated FIG. 8, curved legs 804 located at a bottom of the chassis 320 insert into undercut pockets 808 defined by the housing 118 so as to secure the chassis 320 within the housing 118.

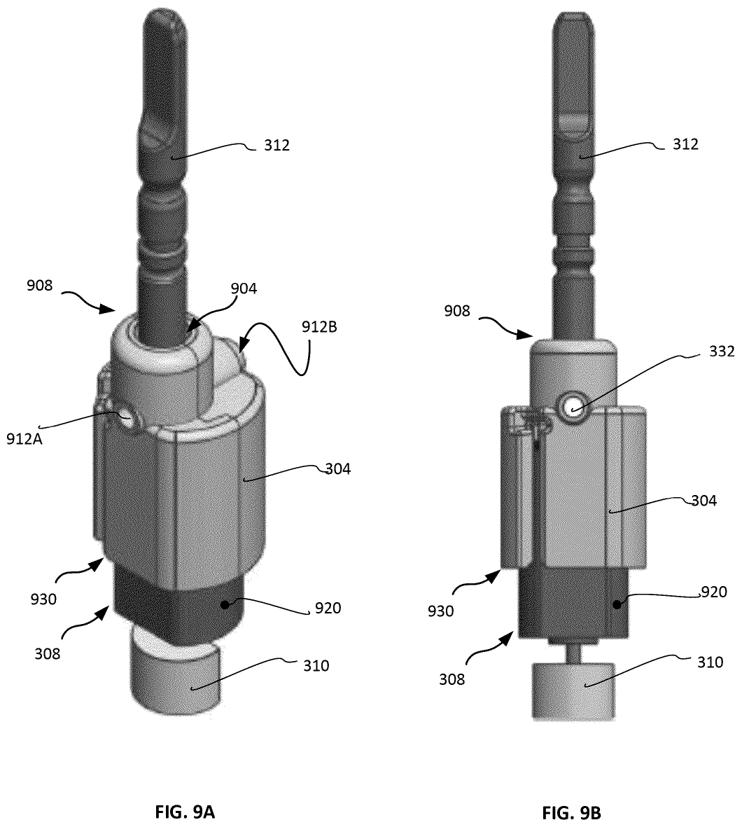

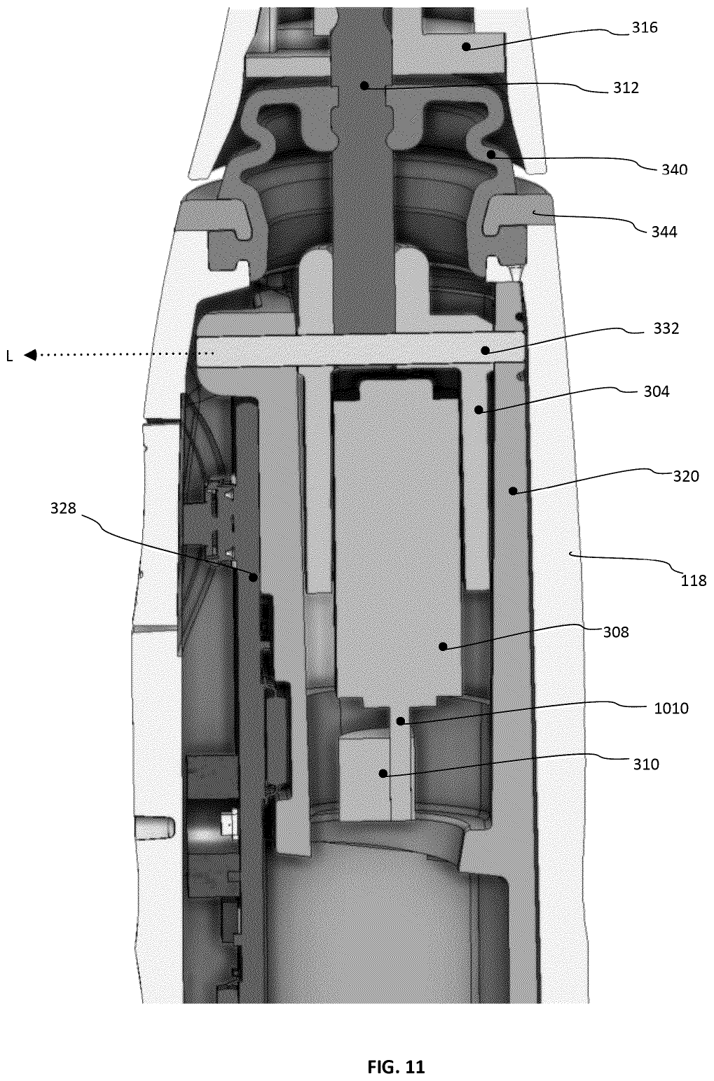

Attention is now directed to FIGS. 9-12, which provide more detailed views of an embodiment of a gimbaled electric vibration motor arrangement in accordance with the disclosure. As shown, the motor cup 304 of the motor cup assembly defines a top aperture 904 proximate an upper end 908 of the motor cup 304. The top aperture 904 circumscribes and secures the shaft member 312. A housing 920 of the electric vibration motor 308 extends through an opening defined by a lower end 930 of the motor cup. The motor cup 304 further defines opposing second and third apertures 912 through which the gimbal pin 332 extends. The gimbal pin 332 may be rotatably disposed within the apertures 912 such that the motor cup 304 is configured to rotate relative to the gimbal pin 332. Alternatively, the gimbal pin 332 is secured to, or integral with, interior surfaces of the apertures 912 and extends into the receiving portions 358 defined by the chassis 320 such that the gimbal pin 332 is configured to rotate within the receiving portions 358. The shaft member 312 may define a central aperture 1004 through which the gimbal pin 332 also extends. As noted above, the motor 308 may be oriented in an opposite configuration in which the eccentric weight 310 of the motor 308 is closer to the toothbrush head assembly 104 than the motor housing 920.

In one embodiment the motor cup 304, shaft member 312 and motor 308 are pre-assembled and may be considered to comprise a single rigid body. The gimbal pin 332 permits this rigid body including the motor 308 to swing side to side but not front to back; that is, the gimbal pin 332 constrains the rigid body including the vibration motor 308 to swing in a plane. As a consequence, the toothbrush head assembly 104 has a side-to-side motion rather than a multi-directional random motion. One advantage of the disclosed embodiments of the toothbrush 100 is that such side-to-side is generally effected using specialized motors which are typically more expensive than the implementations of the vibration motor 308. Thus, the disclosed embodiments of the toothbrush 100 are advantageously configured to produce a preferred sweeping, side-to-side brushing motion generally characteristic of toothbrushes having motors which are more costly to implement than the vibration motor 308. Moreover, although the disclosed gimbal arrangement permits vibrational energy from the vibration motor 308 to be conducted to the toothbrush head assembly 104 with minimal dampening, it also functions to at least partially isolates such energy from the handle housing 118 by essentially precluding motion of the rigid body outside of the desired plane.

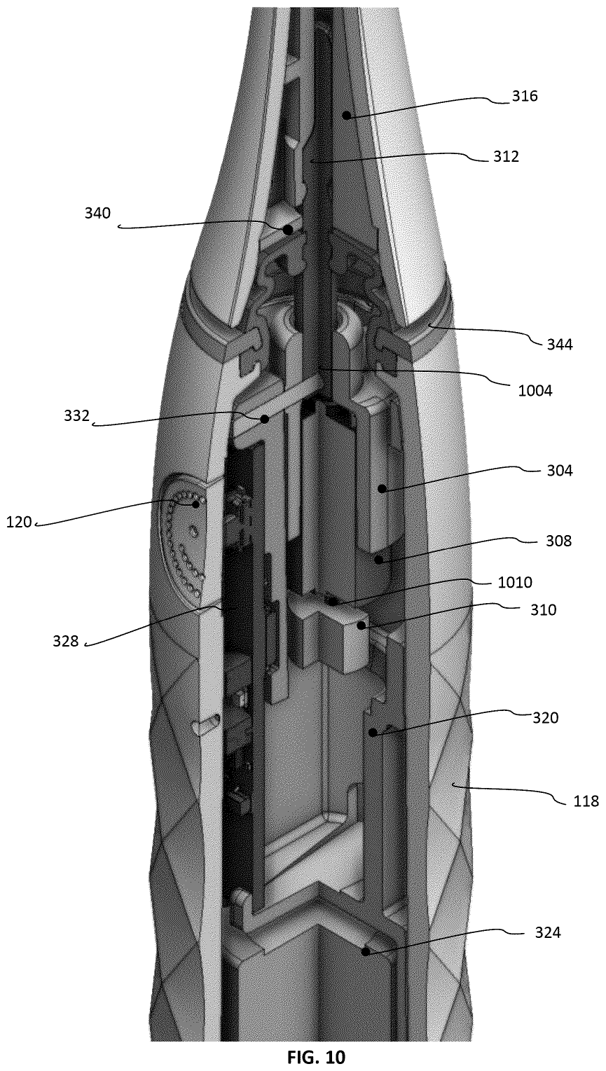

As may be appreciated with reference to FIGS. 10-12, the chassis 320 is dimensioned so as to permit the rigid body including the vibration motor 308 to swing freely about the longitudinal axis L of the gimble pin 332 through an angular displacement sufficient to result in a desired side-to-side excursion of the toothbrush head assembly 104. Orienting the motor 308 such that the motor shaft 1010 to which the eccentric weight 310 is attached extends away from the from the gimbal pin 332 results in a longer lever than when the motor shaft 1010 extends from the housing 920 in the opposite direction. By orienting the motor 308 to create such a longer lever arm, the toothbrush head assembly 104 may move in a side-to-side brushing motion of essentially any reasonably desired amplitude. The boot member 340 will preferably be sufficiently thin and flexible to permit the shaft member 312 to freely move but nonetheless provide an adequate seal around the shaft member 312 to prevent liquid from entering the interior of the body section 114. The chassis 320 may include one or more stops (not shown) in order to limit the swing of the motor 308 to a desired angular displacement.

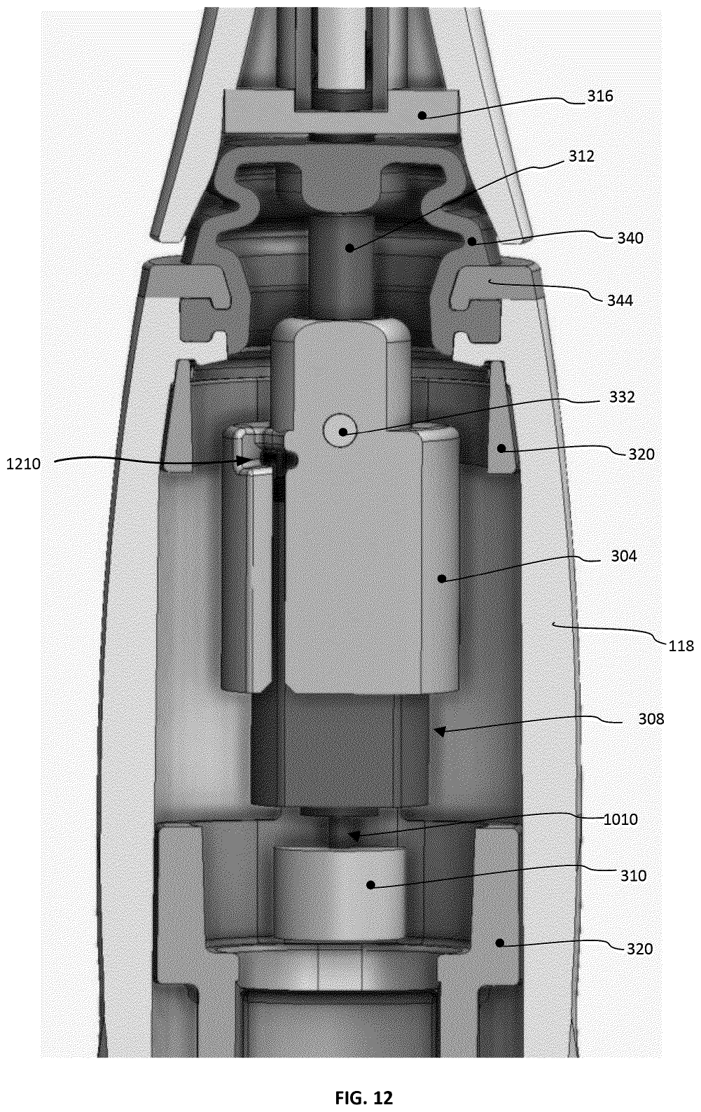

As shown in FIG. 12, the motor cup 304 defines an opening 1210 through which electrical wires connected to the motor 308 may pass through. These wires may, for example, electrically connect the motor 308 to the circuit board 328 and/or the battery 324. The opening 1210 permits such wires to exit the motor cup 304 and the chassis 320 as close to the pivot point defined by the gimbal pin 332 as is reasonably possible so as to minimize the motion of the wires during vibration of the motor 308.

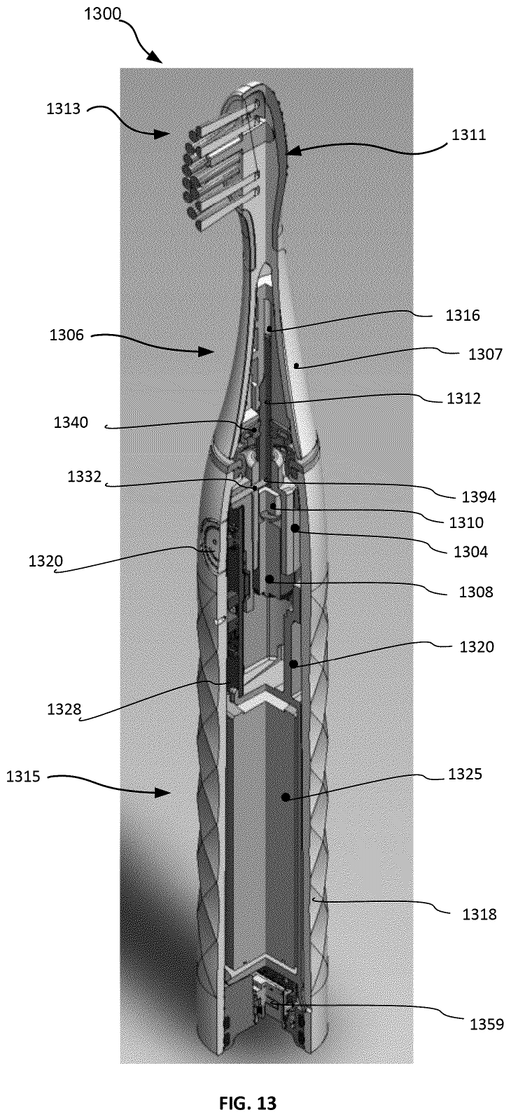

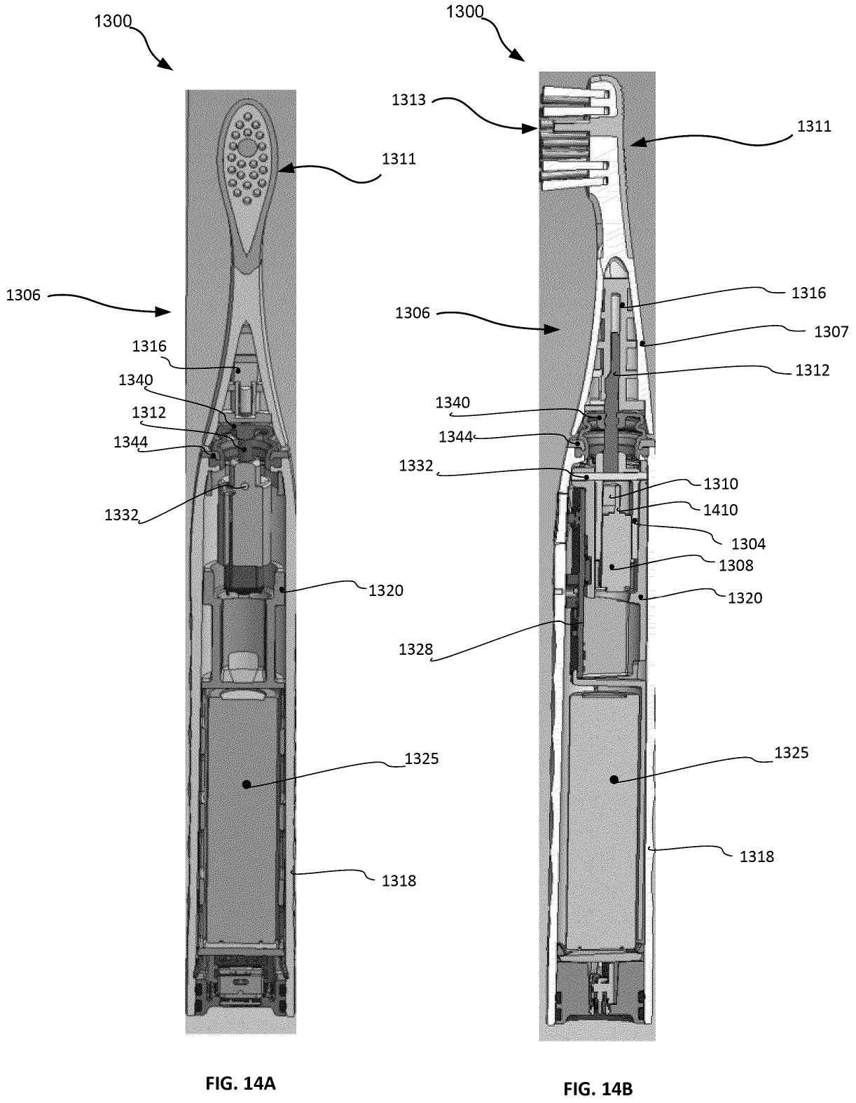

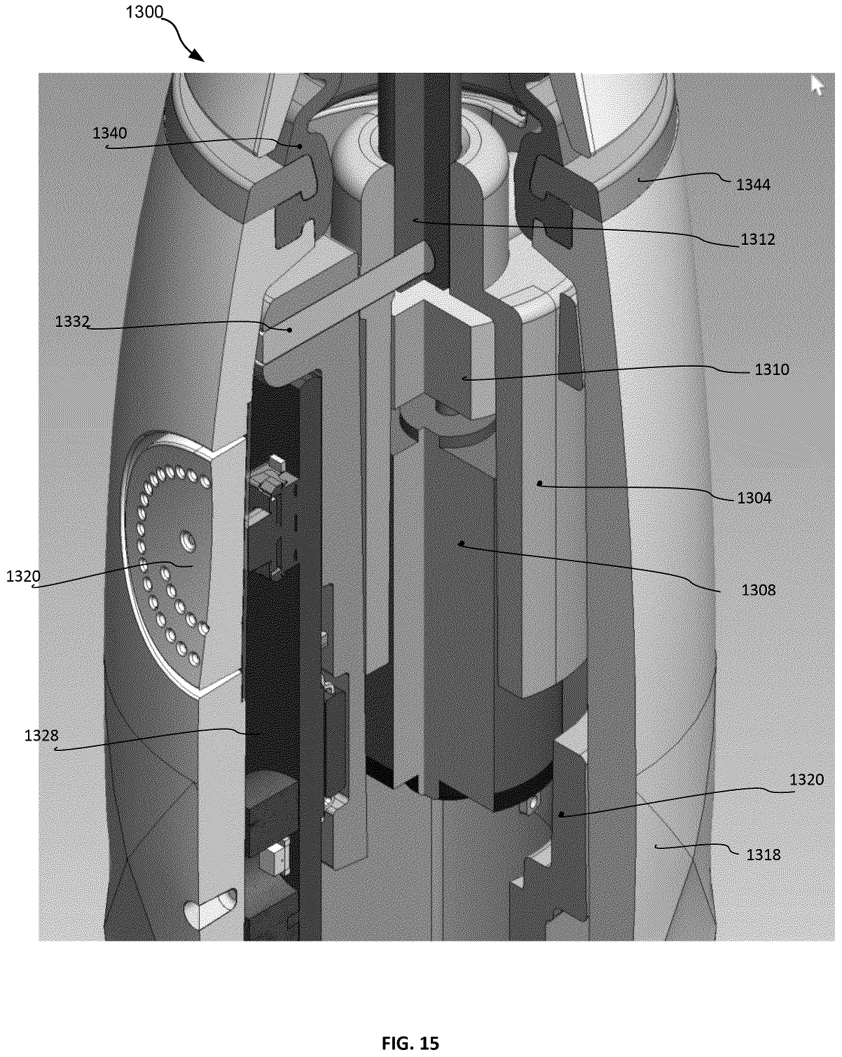

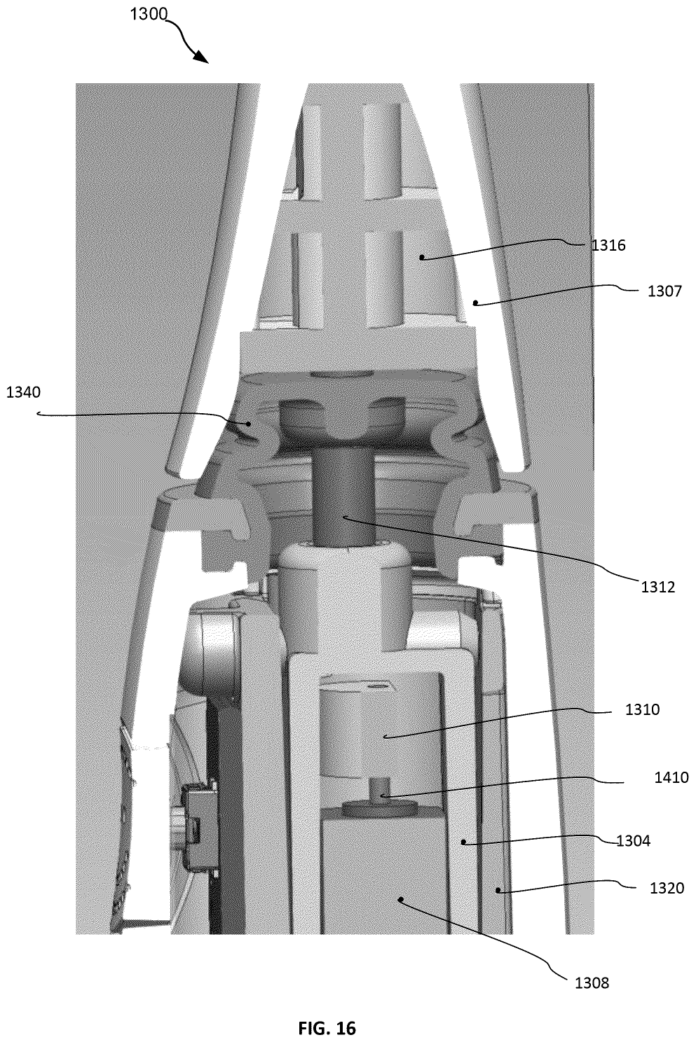

Attention is now directed to FIGS. 13-16, which illustrate an electric toothbrush 1300 containing an alternate orientation of a gimbaled electric vibration motor arrangement in accordance with the disclosure. The toothbrush 1300 may include a replaceable toothbrush head assembly 1306. The replaceable toothbrush head assembly 1306 includes a neck portion 1307 and a toothbrush head 1311 supporting a plurality of bristles 1313 oriented in a direction transverse to the axial direction. The neck portion 1307 may be made of plastic or other materials, and may form a rigid or semi-flexible support for the head 1311. A body section 1315 is of generally cylindrical shape and tapers down in circumference proximate the bottom of the toothbrush head assembly 1306, which may be detached from the body section 1315 to facilitate replacement. A handle housing 1318 of the body section 1315 provides a surface which is gripped by a user's hand during operation of the toothbrush 1300. A control button 1320 may be defined within an upper portion of the body section 1315 in order to enable a user to turn the toothbrush 1300 on or off, select different modes of operation, or adjust speeds or settings associated with a selected operational mode.

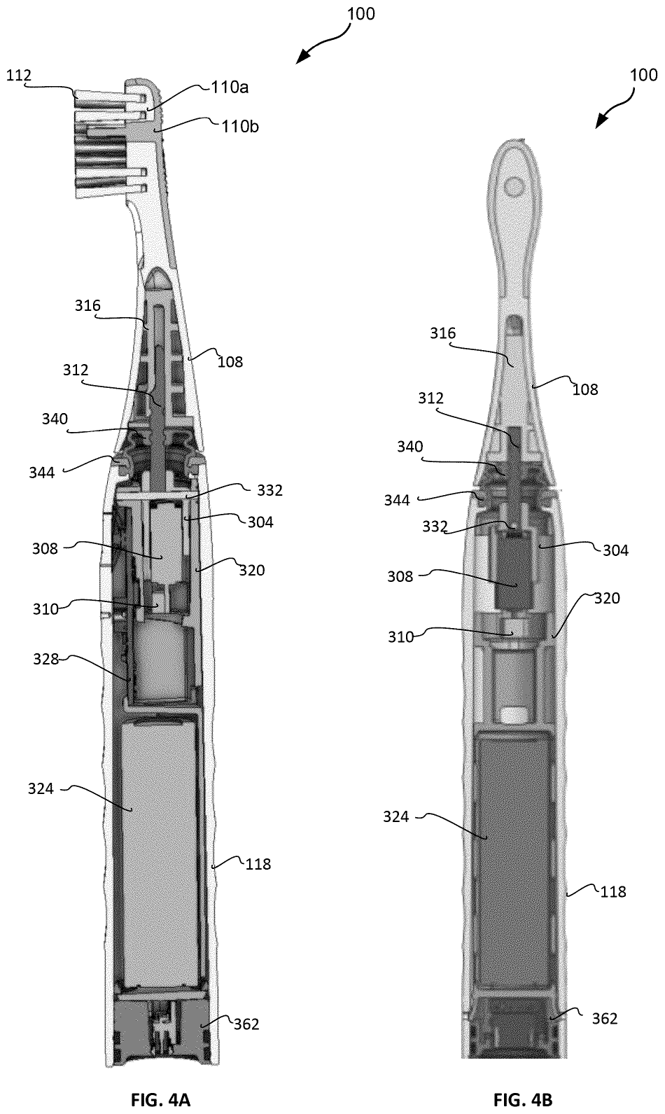

A motor cup assembly includes a motor cup 1304 and an electric vibration motor 1308. The motor 1308, which is secured by the motor cup 1304, has a shaft 1410 to which is attached an eccentric weight 1310. A shaft member 1312 is secured within an aperture defined by an upper end of the motor cup 1304. As may be appreciated by comparing FIGS. 13-16 to FIGS. 4-5 and 9-12, the eccentric weight 1310 is oriented above the motor 1308 when the toothbrush 1300 is in an upright position while the eccentric weight 30 is oriented below the motor 308 when the toothbrush 100 is upright. Although implementations with each of these orientations are possible, positioning the eccentric weight 310 below the motor 308 within the toothbrush 100 increases the length of a lever arm associated with the shaft member 312 relative to the length of a lever arm associated with the ERM vibration motor arrangement within the toothbrush 1300. This may enable implementations of the toothbrush 100 to provide superior performance (e.g., brush head angular displacement) relative to implementations of the toothbrush 1300.

When the toothbrush 1300 is an assembled state, the shaft member 1312 is surrounded by a brush head insert 1316, which fits within the neck portion 1307 of the toothbrush head assembly 1306. A chassis structure 1320 is axially aligned with the motor cup 1304, motor 1308 and shaft member 1312. The chassis structure 1320 may support and secure a battery 1325 as well as a printed circuit board 1328 implementing control electronics. The handle housing 1318 circumscribes the motor cup 1304, the motor 1308, the chassis structure 1320 and the printed circuit board 1328.

The gimbal arrangement of the toothbrush 1300 is substantially identical to the gimbal arrangement of the toothbrush 100 and includes (i) a gimbal pin 1332 oriented substantially perpendicular to the axial direction, (ii) receiving portions defined by the chassis structure 1320 and configured to receive the gimbal pin 1332, and (iii) apertures defined by the motor cup 1304 through which the gimbal pin 1332 extends. A boot member 1340 attaches to the chassis structure 1320 and forms a seal against an external surface of the shaft member 1312 so as to prevent moisture or other contaminants from entering the interior portion of the body section 1315. A retaining ring 1344 is sandwiched between an upper rim of the body section 1315 and a lower rim of the neck portion 1307 of the toothbrush head assembly 1306.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. An electronic toothbrush, comprising:
a toothbrush head assembly extending in an axial direction, the toothbrush head assembly having a neck portion and a toothbrush head supporting a plurality of bristles oriented in a direction transverse to the axial direction;
a motor cup assembly including a motor cup and a shaft member extending into the neck portion of the toothbrush head assembly;
an electric vibration motor secured by the motor cup;
a chassis structure having a longitudinal axis oriented in the axial direction;
control electronics electronically connected to the electric vibration motor;
a handle housing circumscribing the motor cup, the chassis structure and the control electronics;
a gimbal arrangement including a gimbal pin oriented substantially perpendicular to the axial direction and received by the chassis structure, the gimbal arrangement being configured to constrain vibrational displacement of the shaft member arising from vibrational energy produced by the electric vibration motor to within a plane substantially normal to a longitudinal axis of the gimbal pin;
wherein the shaft member causes the toothbrush head assembly to be displaced within the plane.

2. The electronic toothbrush of claim 1 further including a battery secured by the chassis structure.

3. The electronic toothbrush of claim 1 wherein the electric vibration motor is an eccentric rotating mass (ERM) vibration motor including a motor housing and having a non-symmetric weight attached to a motor shaft extending from a first end of the motor housing.

4. The electronic toothbrush of claim 3 wherein the ERM vibration motor is oriented in an inverted configuration in which the first end of the motor housing is displaced farther from the toothbrush head than a second end of the motor housing opposite to the first end of the motor housing.

5. The electronic toothbrush of claim 1 wherein the motor cup defines first and second apertures and wherein the gimbal pin extends through the first and second apertures.

6. The electronic toothbrush of claim 5 wherein the gimbal pin is rotatably disposed within the first and second apertures such that the motor cup is configured to rotate relative to the gimbal pin.

7. The electronic toothbrush of claim 1 wherein the gimbal pin is secured to the motor cup and extends into receiving portions defined by the chassis such that the gimbal pin is configured to rotate within the receiving portions.

8. The electronic toothbrush of claim 5 wherein the shaft member defines a third aperture, the gimbal pin extending through the third aperture.

9. The electronic toothbrush of claim 1 wherein the motor cup includes a first end secured to the shaft member and a second end through which extends a housing of the electric vibration motor, the electronic toothbrush further including a boot member attached to the chassis and forming a seal against an external surface of the shaft member proximate the first end of the motor cup.

10. The electronic toothbrush of claim 1 further including a flexible boot member secured by the chassis structure, the flexible boot member forming a seal against a surface of the shaft member.

11. The electronic toothbrush of claim 3 wherein the ERM vibration motor is oriented so that the first end of the motor housing is closer to the toothbrush head than is a second end of the motor housing opposite to the first end of the motor housing.
